(19) United States
(12) Patent Application Publication
(10) Pub. No.: US 2012/0121759 A1
(43) Pub. Date: May 17, 2012

(54) Method of Preparing Bread

(76) Inventor: Tony Sgroi, Glendale, WI (US)

(21) Appl. No.: 13/295,839

(22) Filed: Nov. 14, 2011

Related U.S. Application Data
(60) Provisional application No. 61/413,194, filed on Nov. 12, 2010.

(51) Int. Cl. A21D 8/04; A21D 15/02

(52) U.S. Cl. 426/19

(57) ABSTRACT

A method of baking bread includes the steps of combining ingredients to form a mass of dough, proofing the dough in the open air, forming individual balls of dough from the mass of dough, forming loaves from the balls of dough, proofing the loaves using a proofing machine, baking the loaves in an oven, removing the loaves from the oven, cooling the loaves, and placing the loaves into bags, and freezing the loaves.

### CROSS-REFERENCE TO RELATED APPLICATIONS

This application claims priority to U.S. Provisional Application No. 61/413,194 filed Nov. 12, 2010, the entire contents of which are incorporated by reference.

### BACKGROUND OF THE INVENTION

The present invention relates generally to a method of preparing bread, and more particularly, to a method of preparing par-baked bread.

### BRIEF DESCRIPTION OF THE DRAWINGS

A preferred exemplary embodiment of the inventive method is illustrated in the accompanying drawings.

In the drawings:

FIG. 1 is a flow chart demonstrating one embodiment of the method of the present invention;

FIG. 2 is a flow chart demonstrating another embodiment of the method of the present invention.

### DETAILED DESCRIPTION

The method of the present invention relates to preparing par-baked bread. Par-baked bread is bread that is partially baked, frozen, and then baked again (usually by a consumer) to complete the baking process. Par-baked bread is desirable because it enables the consumer to consume bread immediately after completion of the baking process, as opposed to consuming bread that may have been sitting on a store shelf long after the baking process has been completed.

One embodiment of this inventive method may include the following steps. A mass of bread dough is prepared by mixing the desirable ingredients together. The volume of ingredients used in conjunction with this method may vary as desired. For example, in one embodiment, ingredients may be used in bulk to yield a high volume of loaves. Once the ingredients have been mixed thoroughly, the mass of dough may be broken down into smaller portions so that the dough may be more easily managed during the preparation of individual loaves of bread. Usually the dough is broken down into the smaller portions by hand.

The portions of dough are placed on a surface, e.g., a stainless steel baking surface, and are then further broken down into smaller balls of dough, e.g., between about 8 oz. and 12 oz. in weight, which will ultimately be formed into the individual loaves of bread. The individual balls of dough may be prepared using one's hands, e.g., the balls of dough may be rolled into balls. In one embodiment, the balls of dough weigh about 10 oz each. Once the individual balls of dough have been formed, the dough is left out, e.g., it is placed on a tray in the open air, and allowed to proof from between about 20 minutes to about 40 minutes. In one embodiment, the dough is allowed to proof for about 30 minutes.

After proofing in the open air, the balls of dough are placed into a loaf sheeter to form individual loafs for baking. In one embodiment, the loaf sheeter may be set to form 8 inch loaves. Once the loaves have been formed using the loaf sheeter, the loaves are placed onto a baking surface, e.g., a wooden board. The baking surface may be sprinkled with a non-stick agent, e.g., corn meal, to prevent the loaves from sticking to the baking surface during the baking process. Thus, the partially baked loaves may be easily removed from the baking surface without damaging the loaves.

While still on the baking surface, the loaves are then loaded into a proofing machine for further proofing. In one embodiment, the humidity level of the proofing machine is set to medium humidity and the proofing time is set to between about 5 minutes and 15 minutes. In one embodiment, the dough is proofed at medium humidity for about 10 minutes. The dough is allowed to proof for the predetermined amount of time, or until the dough has risen, which can be detected by a visual inspection of the dough.

After the loaves have been proofed in the proofer, they are ready to be baked in an oven, e.g., a typical industrial bread-baking oven. The oven may be set to the desired baking temperature while the loaves are proofing so as to increase the efficiency of the baking process. For example, the oven may be set to a baking temperature of between about 325 degrees Fahrenheit and about 375 degrees Fahrenheit. In one embodiment, the oven is set to about 350 degrees Fahrenheit. Once the oven has reached the desired baking temperature, the loaves are placed into the oven for baking. When the desired baking temperature is about 350 degrees Fahrenheit, the loaves are baked for about 15 minutes.

After baking, the loaves are removed from the oven and placed on cooling racks, where the loaves cool in the open air. When the loaves have cooled as desired, e.g., cooled to the touch, each loaf is placed into a specialty par-baked, freezer/baking bags. One example of baking bags that may be used in conjunction with the inventive method is the Bake in Bag® bags sold by Policarta USA. Once the loaves have been placed in the respective bags, the bags are sealed and then placed in a freezer. In one embodiment, the freezer is maintained at a maximum temperature of between at least 0 degrees to 10 degrees Fahrenheit.

After the loaves become frozen, they may be distributed for sale to the end consumer. For example, the frozen loaves may be transported to grocery stores, where they may be placed in a freezer cabinet for sale to consumers.

The specialty bags permit the end user to complete the baking process by placing the partially baked loaf, while still contained in the bag, in an oven and baking the loaf until the baking process is completed. Accordingly, the end consumer is able to consume freshly baked bread. In one embodiment of the inventive method, instructions for completing the baking process are placed on the bag. The bag may also contain a brand or logo indicating to the consumer who prepared the partially baked bread.

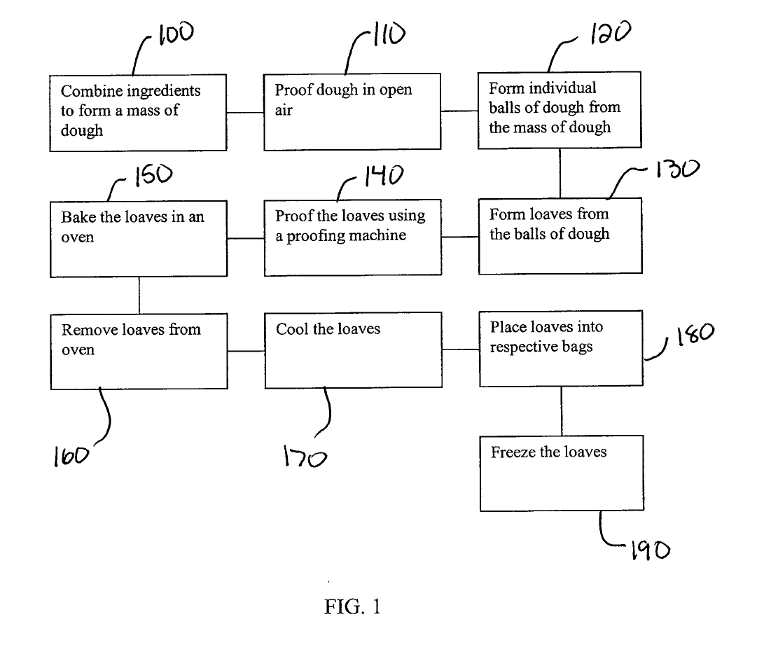

One embodiment of the method of the present invention is illustrated in the flow chart of FIG. 1, which includes the following steps: step 100 involves combining ingredients to form a mass of dough; step 110 involves allowing the mass of dough to proof in open air; step 120 involves forming individual balls of dough from the mass of dough; step 130 involves forming loaves from the balls of dough; step 140 involves proofing the loaves using a proofing machine; step 150 involves baking the loaves in an oven; step 160 involves removing the loaves from the oven; step 170 involves cooling the loaves; step 180 involves placing the loaves into respective bags, and step 190 involves freezing the loaves.

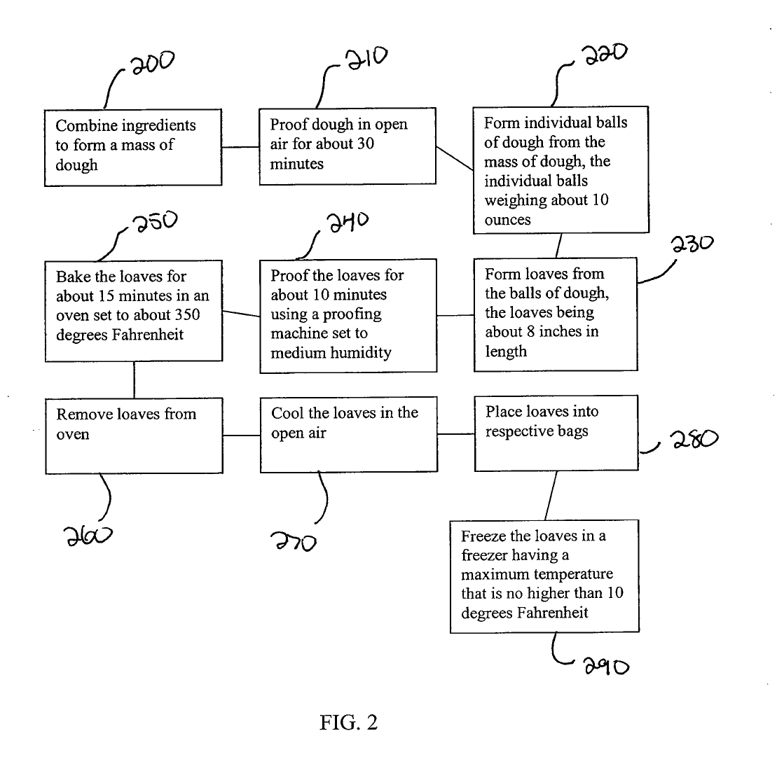

Another embodiment of the method of the present invention is illustrated in the flow chart of FIG. 2, which includes the following steps: step 200 involves combining ingredients to form a mass of dough; step 210 involves allowing the mass of dough to proof in open air for about 30 minutes; step 220 involves forming individual balls of dough from the mass of dough, with the balls of dough weighing about 10 ounces each; step 230 involves forming loaves from the balls of dough, with the loaves being about 8 inches in length; step 240 involves proofing the loaves for about ten minutes using a proofing machine set at a medium humidity level; step 250 involves baking the loaves for about 15 minutes in an oven set at about 350 degrees Fahrenheit; step 260 involves removing the loaves from the oven; step 270 involves cooling the loaves in the open air; step 280 involves placing the loaves into respective bags, and step 290 involves freezing the loaves in a freezer having a maximum temperature that is no higher than 10 degrees Fahrenheit.

Various alternatives and modifications are contemplated as being within the scope of the following claims particularly pointing out and distinctly claiming the subject matter regarded as the invention.

I claim:

1. A method of preparing partially baked bread loaves comprising the steps of:
combining ingredients to form a mass of dough;
proofing the dough in the open air;
forming individual balls of dough from the mass of dough;
forming loaves from the individual balls of dough;
proofing the loaves using a proofing machine;
baking the loaves in an oven;
removing the loaves from the oven once the loaves have been baked for a desired amount of time;
cooling the loaves;
placing individual loaves into respective bags; and
freezing the loaves.

2. The method of claim 1, wherein the dough is proofed in open air for about 30 minutes.

3. The method of claim 2, wherein the loaves are baked for about 15 minutes.

4. The method of claim 3, wherein the loaves are baked in an oven set to about 350 degrees Fahrenheit.

5. The method of claim 4, wherein the loaves are proofed in a proofing machine for about 10 minutes.

6. The method of claim 5, wherein the loaves are frozen in a freezer at a temperature that is no higher than 10 degrees Fahrenheit.
